(19) United States
(12) Patent Application Publication
(10) Pub. No.: US 2026/0295734 A1
(43) Pub. Date: Oct. 1, 2026

(54) DEVICE AND METHOD FOR THE IN-LINE PRODUCTION OF A BLANK FROM A WEB MATERIAL

(71) Applicants: Hanko Kiessner, Salt Lake City, UT (US); Gebr. Scheidt GmbH, Herford (DE)

(72) Inventors: Markus SCHEIDT, Hiddenhausen (DE); Hanko Kiessner, Salt Lake City, UT (US)

(21) Appl. No.: 19/374,166

(22) Filed: Oct. 30, 2025

(30) Foreign Application Priority Data
Oct. 30, 2024 (EP) 24209844.0

(51) Int. Cl. B23K 26/38; B65H 35/00

(52) U.S. Cl. CPC B23K 26/38; B65H 35/008; B65H 2301/51536

(57) ABSTRACT

A device (10) for the in-line production of a blank (50, 52, 54) from a web material, includes a production device (20) for producing a continuous web (30) of the web material and a cutting device (40) for cutting the blank (50, 52, 54) out of the continuous web (30), which is arranged downstream of the production device (20) and includes at least one cutting head (44) which is movable over the continuous web (30) at least transversely to the running direction (x) of the continuous web, wherein the operation of the cutting device (40) is controllable as a function of the running speed of the continuous web (30).

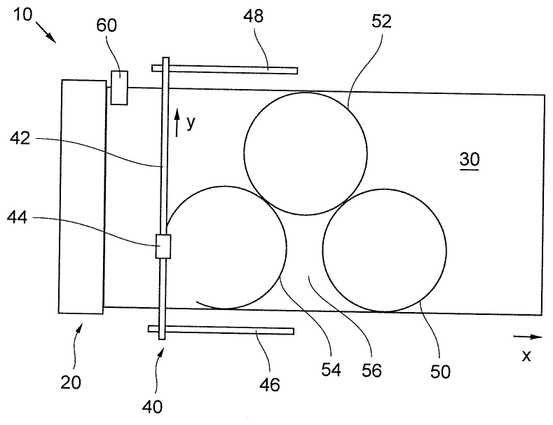

The present invention relates to a device for the in-line production of a blank from a web material and a corresponding method.

Web materials that are produced as continuous webs are known for various applications, for example for packaging. For example, materials made of plastic are known, such as polypropylene (PP), which can be produced efficiently as continuous material using the extrusion process. Such web materials made of plastic can also be extruded as hollow-chamber multiwall sheets, which have a hollow chamber structure inside. Web materials made of solid board or corrugated board are also known, wherein the latter also has an inner profile structure.

In conventional production devices, such continuous webs of plastic or paper materials are cut into rectangular sheets at the end of the production line or wound into rolls and then transported to a separate device for further processing. Such a device is, for example, a punching device in which blanks in various sizes and shapes are punched out with the aid of article-specific punching dies.

The disadvantage here is that the processing process has to be interrupted to collect the sheets (or to roll up the continuous web) for further transportation. There is therefore no continuous processing. Furthermore, the production of blanks using punching dies leads to a relatively large amount of waste, as it is not always possible to achieve a geometrically optimal distribution of the blanks over this surface to minimize the amount of waste. In particular, a margin must always remain for gripping the material sheet during punching, which cannot be used for the blank of the product. This increases material consumption and therefore costs.

It is therefore an object of the present invention to create a device for producing a blank from a web material, which enables continuous production and further processing of the material present as a continuous web with less waste, so that a saving in material and consequently also a saving in costs and resources is achieved.

This object is achieved by a device with the features of claim 1, and a method with the features of claim 9.

The device according to the invention is used for the in-line production of a blank from a web material, i.e., the web material is continuously produced and also further processed. For this purpose, the device according to the invention comprises a production device for producing a continuous web of the web material and a cutting device for cutting out the blank from the continuous web, which is arranged downstream of the production device and comprises at least one cutting head which is movable over the continuous web at least transversely to the running direction thereof. The operation of the cutting device is controllable as a function of the running speed of the continuous web.

The cutting process can therefore be synchronized with the production of the continuous web. For this purpose, the cutting device can be arranged directly downstream of the production device, for example directly after an extruder for hollow-chamber multiwall sheets made of polypropylene. The cutting head can then be moved directly over the surface of the continuous web to carry out the cutting process. A movement “at least transverse to the running direction of the continuous web” is a movement that includes at least one component perpendicular to the running direction of the continuous web. Further movement components are not excluded by this, so that the cutting head can move freely over the plane of the continuous web produced and follow the contour of the blank to be produced.

The control of the cutting device, in particular the cutting head, as a function of the running speed of the continuous web can be realized by a control device which measures the running speed using suitable sensors and uses this as an input variable for controlling the cutting device. The operation of the production device and the cutting device are then directly coupled to each other, so that in-line production of the blank is possible.

The web material blanks are therefore produced within a single device. It is not necessary to collect the web material in sheets or rolls in an intermediate step and transport it to a separate device for further processing.

In addition, cutting to size using a cutting head offers the advantage over a punching device that the blanks can be arranged on the continuous web in a space-saving manner and the full width of the continuous web can be used for this purpose. There is significantly less waste and material is saved.

Preferred embodiments of the invention are described below.

Preferably, the cutting head is also movable in and/or against the running direction of the continuous web. This results in free movement in different spatial directions in one plane across the continuous web. The cutting head can be moved along the continuous web in the manner of a cutting plotter with a Cartesian coordinate system.

The cutting head is also preferably movable along a guide rail that extends perpendicular to the running direction of the continuous web.

According to a further embodiment, the cutting head can be displaced in and/or against the running direction of the continuous web by means of a further guide device attached to the guide rail, or the guide rail itself can be displaced together with the cutting head in and/or against the running direction of the continuous web.

The further guide device can be, for example, a further guide rail that extends in the running direction of the continuous web and thus perpendicular to the first guide rail that extends perpendicular to the running direction of the continuous web. However, embodiments in which the first guide rail itself can be moved along the running direction are also conceivable.

According to a further preferred embodiment of the invention, the cutting head is intended to cut through the web material by mechanical action, by thermal action or by a combination of mechanical and thermal action. It is conceivable, for example, to use a jet of compressed air, a jet of water or an infrared heat jet to cut through the web material.

Preferably, the cutting head is designed as a laser cutting head. The web material is therefore cut through by the action of a laser beam.

The production device is also preferably an extrusion device. This can be an extruder for producing a plastic hollow-chamber profile as web material. The plastic can be polypropylene (PP), for example.

The invention further relates to a method for the in-line production of a blank from a web material, comprising the following steps:
producing a continuous web of the web material,
cutting of the blank from the continuous web by means of a cutting device with at least one cutting head, which is movable at least transversely to the running direction of the continuous web across said continuous web,
   wherein the operation of the cutting device is controlled as a function of the running speed of the continuous web.

According to a preferred embodiment of this method, the cutting head is additionally moved in and/or against the running direction of the continuous web.

Furthermore, the cutting head preferably cuts through the web material during the cutting process by mechanical action, by thermal action or by a combination of mechanical and thermal action.

According to a preferred embodiment of this method, the cutting head cuts through the web material by laser cutting.

Preferably, the continuous web of the web material is produced by extrusion.

In the following, a preferred exemplary embodiment of the present invention is explained in more detail with reference to the drawing.

The only FIGURE shows a schematic top view of one embodiment of the device according to the invention.

The device 10 shown in the FIGURE comprises a production device 20 for producing a continuous web 30 of a web material. In this case, the web material is a plastic such as polypropylene (PP), which is produced as a hollow-chamber profile. For this purpose, the production device 20 in the present exemplary embodiment is designed as an extrusion device. The thickness of the continuous web 30 can be between 1.5 mm and 5 mm, for example.

The continuous web 30 leaves the production device 20 in a direction that will be referred to below as the running direction x of the continuous web 30. In the FIGURE, the plane of the continuous web 30 lies in the plane of the drawing and the running direction x points to the right.

The freshly extruded continuous web 30 is supported on a bed, not depicted in detail, above which a cutting device 40 is arranged for cutting out a blank from the continuous web 30. In detail, the cutting device 40 comprises a guide rail 42 which extends perpendicularly to the running direction x of the continuous web 30 across said continuous web. A cutting head 44 is movable along this guide rail 42 transversely to the running direction of the continuous web and across it. In the present case, the rail 42 is dimensioned such that the cutting head 44 can move over the entire length of the rail 42 and over the entire width of the continuous web 30.

Furthermore, the cutting device 40 comprises a pair of further rails 46, 48 which are arranged on both sides of the continuous web 30 and which extend along the running direction of the continuous web 30. Along these further rails 46, 48, the vertical guide rail 42 can be moved in and against the running direction x of the continuous web 30 together with the cutting head 44.

The guide rail 42 and the pair of further rails 46, 48 together with the cutting head 44 form a cutting plotter by means of which the cutting head 44 can be guided over the surface of the continuous web 30 in a Cartesian coordinate system. The abscissa of this coordinate system represents the running direction x, while the ordinate corresponds to the direction of extension of the guide rail 42 for the cutting head 44, i.e., the transverse direction y to the running direction x.

In the present case, the cutting head 44 is designed as a laser cutting head and is intended to cut out blanks 50, 52, 54 from the continuous web 30. By way of example only, the contours of these blanks 50, 52, 54 are shown here as circles or circular blanks which are produced along their numbering in the continuous web 30, i.e., the production of the blank 52 follows the production of the blank 50, while the production of the blank 54 in turn follows the blank 52.

The blank 54 is not yet completed in the representation of the FIGURE, i.e., the representation represents a snapshot of the cutting out of the blank 54 by the cutting head 44. Incidentally, the representation of the blanks 50, 52, 54 is merely an exemplary selection, and it is understood that the blanks 50, 52, 54 can be produced in a continuous sequence along the running direction x.

To produce the blanks 50, 52, 54, the cutting head 44 must be moved in a circle in relation to the surface of the continuous web 30, while the continuous web 30 simultaneously moves in the running direction x. To ensure that the contour of the blanks 50, 52, 54 can be cut with geometric precision, the running speed of the continuous web 30 is used to control the operation of the cutting device 40. For this purpose, the device 10 comprises a sensor 60 for measuring the current speed of the continuous web 30. The output signal of this sensor 60 is received by a control device, not depicted in detail, which controls the movement of the cutting head 44 during the cutting out of the blank 50, 52, 54.

The present device 10 is thus suitable for the in-line production of blanks 50, 52, 54 from a continuously produced continuous web 30 without intermediate steps. In particular, it is not necessary to first collect the web material of the continuous web 30 produced by the production device 20 (in this example: the extrusion device) and to transport it to a further processing station in which the blanks are produced from it. Rather, the blanks 50, 52, 54 are direct products of the device 10. They can then be removed directly from the surrounding material 56 of the continuous web 30, which can then be recycled or disposed of as waste 56.

Deviating from the present embodiment, the cutting head 44 can be intended to cut through the web material by mechanical action, for example by a jet of compressed air or a jet of water, or also by thermal action such as infrared radiation. A combination of such methods, including one involving the use of laser light, is conceivable within the scope of the present invention.

Moreover, the extrusion device used in the present case can be replaced by another type of production device 20. For example, the web material can be solid board or corrugated board, which is produced in a continuous process by the production device 20.

1-12. (canceled)

13. A device for the in-line production of a blank from a web material, comprising:
a production device for producing a continuous web of the web material and
a cutting device for cutting the blank out of the continuous web, which is arranged downstream of the production device and comprises:
at least one cutting head which is movable over the continuous web at least transversely to the running direction of said continuous web, and
an arrangement for controlling the operation of the cutting device as a function of the running speed of the continuous web.

14. The device according to claim 13, wherein the at least one cutting head is additionally movable at least one of in and against the running direction of the continuous web.

15. The device according to claim 13, further comprising a first guide rail which extends perpendicular to the running direction of the continuous web across said continuous web, and the cutting head is displaceable along the guide rail.

16. The device according to claim 15, further comprising a further guide device attached to the first guide rail, and one of:
the cutting head is displaceable in and against the running direction of the continuous web by the further guide rail, or
the first guide rail itself is displaceable together with the cutting head at least one of in and against the running direction of the continuous web.

17. The device according to claim 13, wherein the cutting head is intended to cut through the web material by one of:
mechanical action,
thermal action or
a combination of mechanical action and thermal action.

18. The device according to claim 13, wherein the cutting head is a laser cutting head.

19. The device according to claim 13, wherein the production device comprises an extrusion device.

20. A method of in-line production of a blank from a web material, comprising the steps of:
producing a continuous web of the web material,
cutting out the blank from the continuous web by a cutting device having at least one cutting head which is movable over the continuous web at least transversely to a running direction of said continuous web, and
controlling the operation of the cutting device as a function of the running speed of the continuous web.

21. The method according to claim 20, further comprising the step of additionally moving the cutting head at least one of in and against the running direction of the continuous web.

22. The method according to claim 20, wherein the step of cutting including cutting through the web material with the cutting head during the cutting step by one of:
mechanical action,
thermal action or
a combination of mechanical action and thermal action.

23. The method according to claim 20, the cutting head cuts through the web material by laser cutting.

24. The method according to claim 20, wherein the step of producing includes the step of producing the continuous web of the web material by extrusion.
